(19) United States
(12) Patent Application Publication
(10) Pub. No.: US 2004/0138990 A1
(43) Pub. Date: Jul. 15, 2004

(54) System and method for providing home financing

(75) Inventors: Loraine Hardin, Clive, IA (US); Sara Raley, Clive, IA (US); Edward C. Burdzy, Clive, IA (US); Charlotte I. Catalfo, Clive, IA (US)

Correspondence Address: MCKEE, VOORHEES & SEASE, P.L.C., 801 GRAND AVENUE, SUITE 3200, DES MOINES, IA, 50309-2721, US

(73) Assignee: Principal Financial Services, Inc., Des Moines, IA

(21) Appl. No.: 10/342,062

(22) Filed: Jan. 14, 2003

(51) Int. Cl. G06F 17/60

(52) U.S. Cl. 705/38; 705/35

(57) ABSTRACT

A method for providing home financing is disclosed. The method includes providing a retirement plan to a participant, marketing a home loan program to the participant, receiving a request for a home loan from the participant, and using salary information and balance information associated with the retirement plan to approve a home loan for the participant without requiring separate verification of salary and retirement plan balance information. A system for home financing is also disclosed. The system includes a retirement plan providing unit for providing an employer sponsored retirement plan having a participant, a home financing unit for providing home financing loans, and means for sharing information between the retirement plan providing unit and the home financing unit to verify proof of employment, income, and assets for the participant for approving a home financing loan through information associated with the employer sponsored retirement plan.

### BACKGROUND OF THE INVENTION

Borrowers often look at the process of acquiring financing for buying a home or refinancing an existing home as a difficult and time-consuming process. Indeed, it usually is. In addition to a lengthy loan application, additional documentation is required. In particular, documentation needed to verify information on the loan application is required. Such verification information typically includes proof of employment and proof of income through the most recent month of pay stubs, proof of past income through income tax returns, and proof of asset reserves through bank statements or other account statements.

The amount of information required is not just burdensome on the borrower, but also on the lender. The lender must scrutinize the information received from the borrower and verify the information. It is important to the lender to verify all of this information to reduce the risk of making a loan that the borrower will default on. This collection and verification of information requires a significant expenditure of time and resources by the lender and increases the cost of home ownership.

In a typical home financing loan, the information collected can include original pay stubs from at least 30 days prior to loan application until closing, W-2 forms for the previous two years, bank statements for at least two months prior to loan application for checking and saving accounts, contact information for the borrower's landlord for the last 24 months prior to application, original 401(k) and IRA statements, at least the last 12 cancelled mortgage/rent checks, a copy of signed lease and past two years tax returns on any rental property, and other documentation. Thus there is a significant amount of documentation that must be collected by the borrower and verified by the lender. The lender considers it important to collect (and verify) as much information as possible in order to have a full and accurate understanding of the state of the borrower's finances and the borrower's financial history to assess the borrower's ability to repay the loan. Thus collection and verification of information in the home financing process is burdensome on both the borrower and lender, but is considered necessary by the lender to protect their investment.

Therefore it is a primary object, feature, or advantage of the present invention to improve over the state of the art.

It is another object, feature, or advantage of the present invention to improve the customer's experience and reduce the overall cost of home ownership.

It is a further object, feature, or advantage of the present invention to provide a method and system for financing homes that reduce the amount of time a borrower must spend to secure financing.

Another object, feature, or advantage of the present invention is to provide a method and system for financing homes that reduces the time from loan application to closing.

Yet another object, feature, or advantage of the present invention is to provide a method and system for financing homes that reduces the time and resources required by a lender to verify loan application information.

A further object, feature, or advantage of the present invention is to provide a method and system for financing homes that streamlines the financing process while still reasonably protecting the lender from making loans that result in default.

### SUMMARY OF THE INVENTION

According to one aspect of the present invention, a method for home financing is provided. The method includes providing a retirement plan to a participant, marketing a home loan program to the participant, receiving a request for a home loan from the participant, and using salary information and balance information associated with the retirement plan to approve a home loan for the participant without requiring separate verification of salary and retirement plan balance information.

According to another aspect of the present invention, a system (processes, procedures, data and technology) for home financing is provided. The system includes a retirement plan provider offering and administering employer sponsored retirement plans and having access to the plan participants. A home financing unit is used for providing home loans. There is also a means for sharing information, between the retirement provider and the home financing unit. This information, associated with the employer-sponsored retirement plan, is used to verify proof of employment, income, and assets for the participant, allowing for approval of the home financing loan.

### BRIEF DESCRIPTION OF THE DRAWINGS

FIG. 1 is a flow diagram showing information flow for a system according to one embodiment of the present invention.

FIG. 2 is a pictorial representation of a computer display showing retirement plan participant information according to one embodiment of the present invention.

FIG. 3 is a pictorial representation of a computer display showing account information for a participant's retirement plan according to one embodiment of the present invention.

FIG. 4 is a pictorial representation of a computer display showing historical employment information for a participant according to one embodiment of the present invention.

### DETAILED DESCRIPTION OF THE INVENTION

The present invention relates to home financing. More particularly, the present invention relates to an approved method and system for providing home financing that provides the advantages of reduced borrower commitment of time in the application process and reduced time from application to closing. The present invention provides for using information associated with an employer-sponsored retirement plan to verify information provided by a borrower making an application for a home financing loan.

At the core of this invention is the recognition that the two largest assets consumers typically have today are their 401(k) account and the equity in their home, and to reward a customer for saving through a 401(k) vehicle. The reward comes in the way of looking at their financial situation holistically and reducing the requirements when applying for credit for a home loan. This further recognizes that a 401(k) vehicle and paying down a home loan, which creates equity, are the two most efficient savings vehicles for U.S. consumers today.

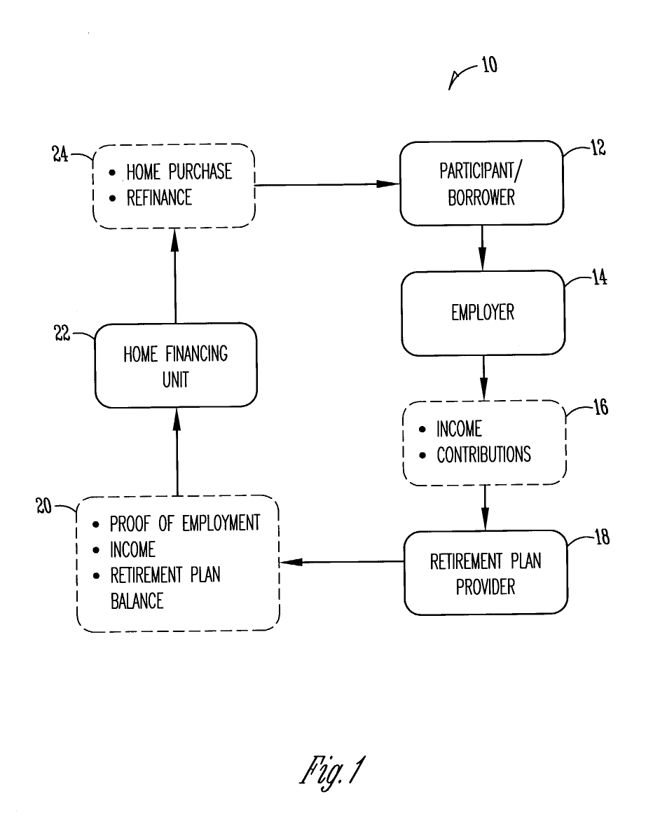

FIG. 1 illustrates information flow for a system according to one embodiment of the present invention. The system 10 includes a borrower 12 who is also a participant in an employer-sponsored retirement plan such as a 401(k) plan. The employer 14 is also shown. The employer 14 sends information 16 associated with the employer-sponsored retirement plan to the retirement plan provider 18. The information can include income information and contribution information and other information associated with the retirement plan. Other information concerning the retirement plan can also be communicated to the retirement plan provider 18 from the participant/borrower 12. Various methods for collecting this information can be used and need not be discussed for a proper understanding of the present invention, however U.S. Published Application 2001/0037276 is herein incorporated by reference in its entirety, to provide such disclosure.

The retirement plan provider 18 can directly communicate verification information 20 to a home financing unit 22 upon application from the participant. Preferably, the retirement plan provider 18 and home financing unit 22 are both business units of the same organization. The present invention contemplates other types of relationships between the retirement plan provider 18 and the home financing unit 22, however, preferably the retirement plan provider 18 and the home financing unit 22 are closely related to facilitate the home financing unit 22 obtaining the verification information 20 from the retirement plan provider 18. The verification information can include proof of employment for the participant/borrower 12, current and historical income for the participant/borrower 12, retirement plan account balance for the participant/borrower 12, and other verification information that can be used to verify or validate information given on a home financing application by the participant/borrower 12. Verifying the retirement plan account balance verifies one of the assets of the participant/borrower. Typically, a home and a 401(k) are a person's two greatest financial assets.

Once the home financing unit 22 approves a home financing loan, the home financing unit 22 provides the loan 24 to the borrower/participant 12. The loan 24 can be a loan for a home purchase, a loan for refinancing of a home without cash back to the borrower, or a loan for refinancing of a home with cash back to the borrower. The refinancing can be a rate or term refinancing, whether the rate or the term is reduced.

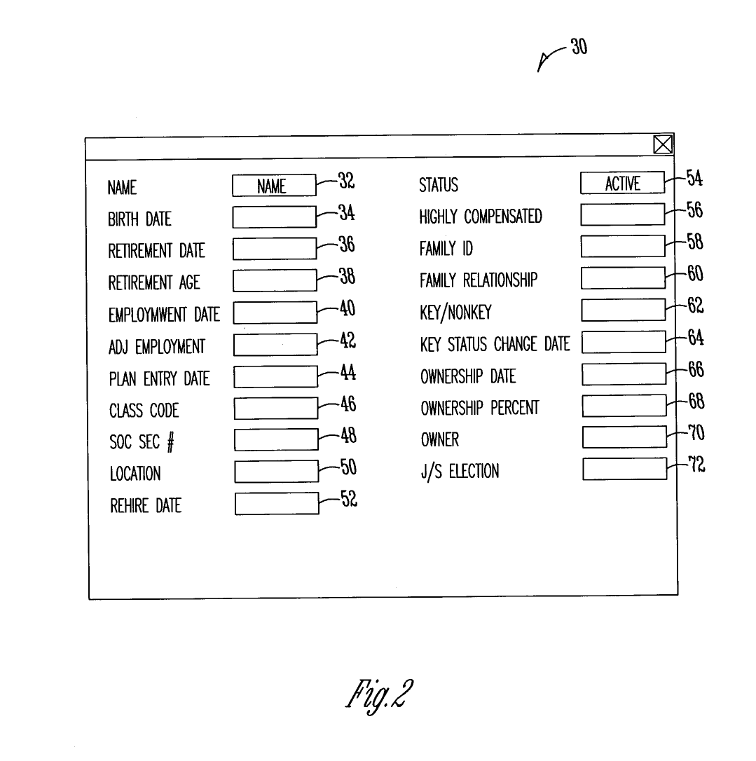

The present invention contemplates that various means can be used to provide information 20 from the retirement plan provider 18 to the home financing unit 22. Preferably, such information is provided via computer access, however the same information could be provided in other ways, such as via paper, telephone, fax, or other means. FIGS. 2-4 show computer access to information 20 from the retirement plan provider 18.

FIG. 2 illustrates a computer display showing retirement plan participant information according to one embodiment of the present invention. A computer display screen 30 provides various information about a participant/borrower 12. The information can include the name 32 of the participant, the birth date of the participant, the retirement date 36 of the participant, the retirement age 38 of the participant, the employment start date 40 of the participant, information related to other employment 42, the date on which the participant first entered the plan 44, a class code 46 associated with the participant, a social security number 48 associated with the participant, a location 50 associated with the participant, a rehire date 52 associated with the participant, a status 54 (such as “active” or “inactive”) associated with the participant, whether the participant is highly compensated 56, a family identification 58 associated with the participant, a family relationship 60 associated with the participant, whether the participant is considered a key or nonkey employee 62, the date of a key status change 64, a date associated with ownership beginning 66, a percent ownership 70, a joint/single election 72. The present invention is in no way limited to the particular data fields disclosed herein. The present invention contemplates that other information can be accessed that would be associated with a participant in a retirement plan if required or desirable for home financing purposes. Some of the information may be plan specific. The information shown in FIG. 2 is consistent with information about a participant that is associated with a 401(k) retirement plan.

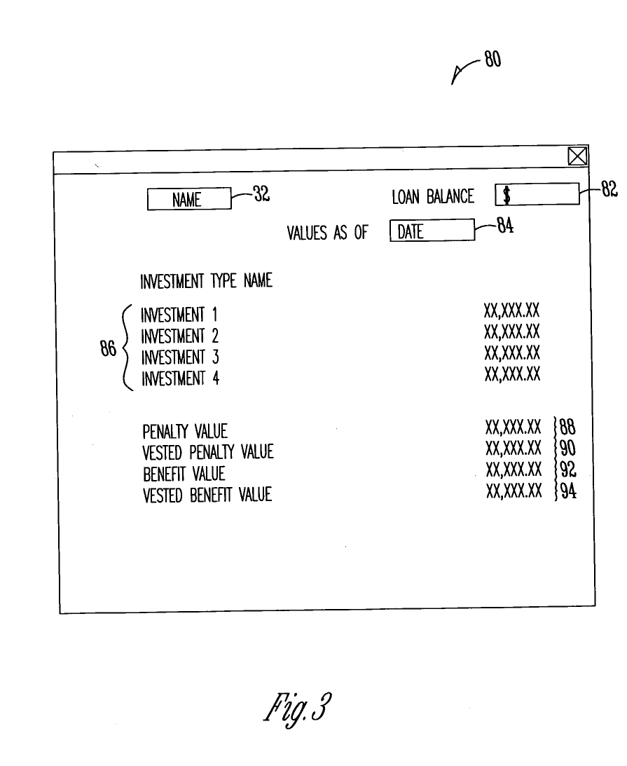

FIG. 3 is a pictorial representation of a computer display showing account information for a participant's retirement plan according to one embodiment of the present invention. In FIG. 3, the screen display 80 includes the name 32 of the participant and a loan balance 82 of the participant. In addition, a date 84 associated with the current values of the investments within the retirement plan is provided. Various investments 86 are listed along with their associated monetary values. In addition, total values, such as a penalty value 88, a vested penalty value 90, a benefit value 92, and a vested benefit value 94 are also provided. The present invention contemplates that less information, additional information, or alternative information can be provided if useful for home financing purposes. Preferably, such information is provided by consent of the participant. The information provided includes, however, some total or verification of the value of the retirement account and any loan balance if applicable.

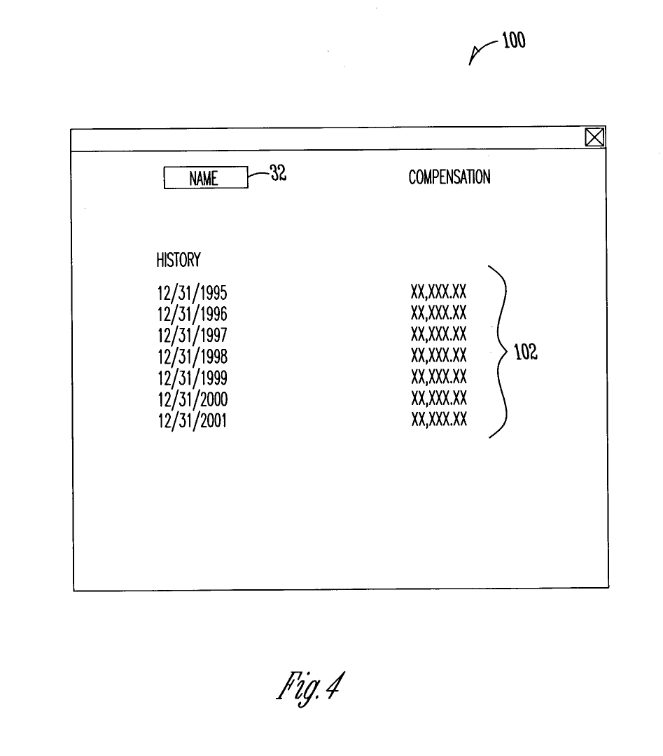

FIG. 4 is a pictorial representation of a computer display showing historical employment information for a participant according to one embodiment of the present invention. The computer display 100 of FIG. 4 includes the name 32 of the participant and historical salary information 102. The historical salary information 102 can be used to verify the income history of the participant.

The present invention contemplates numerous variations in the specific methodology used. In one embodiment, information from the retirement plan provider is used to determine potential retirement plan participants who would be presented the opportunity for preferred home financing. For example, such persons could be presented the opportunity for preferred home financing on the basis of having an income of at least a first amount and a retirement account balance of at least a second amount. The first amount can be $75,000 or greater and the second amount can be $25,000 or greater, however, the present invention contemplates that these amounts could also be lower, could vary from real estate market to real estate market, and could vary with interest rates or the general lending climate. The present invention provides for marketing the opportunity for preferred home financing to retirement plan participants in a manner that provides the participant/borrower incentives to apply for a home financing loan from the home financing unit. These incentives can include a reduced interest rate, such as a reduction of 0.125 percent. These incentives can also include a reduction in origination fee or even a fixed fee instead of a standard one percent origination fee. Also, there is the incentive of less time commitment required by the participant/borrower and the incentive of less time from loan application to closing.

The incentives are possible for the home financing unit due to various savings incurred. For example, significantly less resources and time will be required to verify employment, income, and assets. In addition, there would be a higher rate of loan approvals where there are already the predetermined income and retirement account balance minimums. There is also the opportunity to cross-sell other finance, banking, and insurance products to the same participant/borrowers.

In addition, the present invention provides for simplifying the home financing process for borrowers and lenders, as according to the present invention, not as much information need be collected or verified. In addition to quickly and easily verifying income and asset information, other documentation that is normally required in home financing need not be collected. For example, the past two years of tax returns need not be collected or reviewed. Other information concerning checking and savings accounts, IRA, statements, and other documentation also need not be the basis for a loan approval. The process is preferably streamlined to a point that application for home financing can be made and approved over the phone in the same phone call.

Thus, a system and method for providing home financing has been disclosed. The present invention contemplates numerous variations within the spirit and scope of the invention.

What is claimed is:

1. A method for providing home financing comprising:
providing a retirement plan to a participant;
marketing a home loan program to the participant;
receiving a request for a home loan from the participant; and
using salary information and balance information associated with the retirement plan to approve a home loan for the participant without requiring separate verification of salary and balance information.

2. The method of claim 1 further comprising associating an incentive with the home loan program for encouraging the participant to submit the request for the home loan.

3. The method of claim 2 wherein the incentive includes a fixed origination fee and not a percentage based origination fee.

4. The method of claim 2 wherein the incentive includes a reduction in an interest rate associated with the home loan.

5. The method of claim 2 wherein the retirement plan is a defined contribution retirement plan.

6. The method of claim 1 wherein the retirement plan is sponsored by an employer of the participant.

7. The method of claim 1 wherein the home loan is a home purchase.

8. The method of claim 1 wherein the home loan is a rate/term refinance.

9. The method of claim 8 wherein the refinance is a cash-out refinance.

10. The method of claim 1 wherein the participant is required to have a retirement plan balance of at least a first amount.

11. The method of claim 1 wherein the participant is required to have an income of a second amount.

12. The method of claim 1 further comprising receiving an application from and approving a home loan for the participant during a single phone call.

13. The method of claim 1 wherein the salary information includes historical salary information.

14. The method of claim 1 wherein the participant is required to have exhibited a savings pattern.

15. A system for providing home financing, comprising:
a retirement plan providing unit for providing an employer sponsored retirement plan having a participant;
a home financing unit for providing home financing loans;
means for sharing information between the retirement plan providing unit and the home financing unit to verify proof of employment, income, and assets for the participant for approving a home financing loan through information associated with the employer sponsored retirement plan.

16. The system of claim 15 wherein the employer sponsored retirement plan is a 401(k) plan.

17. The system of claim 15 wherein the home financing loan is for a home purchase, rate/tern refinance or cash-out refinance.
